(19) United States
(12) Patent Application Publication
(10) Pub. No.: US 2005/0248200 A1
(43) Pub. Date: Nov. 10, 2005

(54) Vehicle seat

(76) Inventors: Bernard Pradier, St Michel Sur Orge (FR); Christophe Aufrere, Montlhery (FR)

Correspondence Address: FISH & RICHARDSON PC, P.O. BOX 1022, MINNEAPOLIS, MN, 55440-1022, US

(21) Appl. No.: 11/122,754

(22) Filed: May 5, 2005

(30) Foreign Application Priority Data
May 10, 2004 (FR) FR 04 05029

(51) Int. Cl. B60N 2/02

(52) U.S. Cl. 297/378.1

(57) ABSTRACT

A vehicle seat comprising a seat proper and a seat back comprising a bottom portion pivotally mounted on the seat proper via a first hinge mechanism situated on a first side of the seat back, and a top portion pivotally mounted on the bottom portion via a second hinge mechanism situated on the second side of the seat back, the top portion being mounted to pivot freely on the bottom portion on the first side of the seat back. On said second side, one of the cheek plates of the first hinge mechanism is connected to the bottom portion of the seat back by a locking member making it possible either to secure said cheek plate to the bottom portion of the seat back, or to allow said bottom portion of the seat back to pivot freely.

### FIELD OF THE INVENTION

The present invention relates to vehicle seats.

More particularly, the invention relates to a vehicle seat comprising a seat back and a seat proper, the seat back having opposite first and second sides, and comprising, at least:
a bottom portion mounted to pivot on a support framework about a first transverse horizontal pivot axis;
a top portion mounted to pivot on the bottom portion about a second transverse horizontal pivot axis, parallel to the first axis;
at least one first hinge mechanism adapted to make it possible to adjust the angular position of the seat back relative to the support framework, said hinge mechanism having a first cheek plate fastened to the support framework and a second cheek plate connected to the bottom portion of the seat back by a locking member that is movable between firstly a locking position in which said locking member secures the second cheek plate to the bottom portion of the seat back at least in a normal in-use angular position, and secondly an unlocking position in which said locking member makes it possible for the bottom portion of the seat back to pivot freely relative to the support framework, at least for the purpose of folding down said bottom portion from its normal in-use position to a tilted-forwards position;
a second hinge mechanism connecting the top portion of the seat back to the bottom portion and actuatable so as selectively either to secure the top portion of the seat back to the bottom portion, or to allow the top portion of the seat back to pivot relative to the bottom portion about the second axis, at least for the purpose of folding down said top portion from the normal in-use position to a folded-down forwards position.

### BACKGROUND OF THE INVENTION

Document FR-A-2 840 267 describes an example of such a vehicle seat which gives full satisfaction.

### OBJECTS AND SUMMARY OF THE INVENTION

An object of the present invention is to improve that known seat further, in particular by improving the compactness of the mechanical system for enabling the seat back to perform those various movements.

To this end, according to the invention, in a seat of the type in question, the first and second hinge mechanisms are disposed on respective ones of the first and the second sides of the seat back, the top portion of the seat back being connected to the bottom portion of said seat back via a freely pivoting mount on the first side of the seat back.

By means of these provisions, the mechanical system for coupling together the support framework, the bottom portion of the seat back, and the top portion of the seat back is made more compact because, on the first side of the seat back, a mere pivot that is very compact is associated with a less compact hinge mechanism and with a less compact locking member. It is thus possible, in particular, to obtain a seat whose above-mentioned first and second axes are close to each other.

In preferred embodiments of the invention, it is optionally possible to use one or more of the following provisions:
the locking member comprises a lever that is mounted to pivot on the bottom portion of the seat back, and said lever can be moved towards the second axis when the locking member goes from its locking position to its unlocking position;
the second cheek plate of the first hinge mechanism is secured to an intermediate framework provided with a notch, and the lever is provided with a hook adapted to engage into said notch in said locking position;
the bottom portion of the seat back is connected to the support framework on the second side of the seat back, by a third hinge mechanism similar to the first hinge mechanism, the first and third hinge mechanisms being actuated in synchronized manner by a common control so as selectively to lock or release the bottom portion of the seat back in rotation relative to the support framework, and the bottom portion of the seat back is urged resiliently to pivot forwards relative to the support framework;
the common control of the first and third hinge mechanisms is coupled to a second control member actuating the second hinge mechanism, so as to unlock the first and third hinge mechanisms when said control member is actuated to unlock the second hinge mechanism;
the common control of the first and third hinge mechanisms is connected to said control member of the second hinge mechanism by coupling means adapted to unlock the first and third hinge mechanisms prior to unlocking the second hinge mechanism when said control member is actuated;
the common control of the first and third hinge mechanisms is connected to the control member of the second hinge mechanism by means of a first Bowden cable;
the locking member is coupled to an actuating member that controls the third hinge mechanism so as to unlock said third hinge mechanism when the locking member is in the unlocking position, said actuating member being adapted not to act on the common control when it is actuated, so that the first hinge mechanism then remains locked; and
the locking member is coupled to the actuating member of the third hinge mechanism via a second Bowden cable.

### BRIEF DESCRIPTION OF THE DRAWINGS

Other characteristics and advantages of the invention appear from the following description of an embodiment thereof, given by way of non-limiting example, and with reference to the accompanying drawings.

In the drawings:

FIG. 1 is a diagrammatic view of the framework of an embodiment of a vehicle seat of the invention, in the normal in-use position;

FIGS. 2 and 3 are perspective front quarter views showing the framework of the seat back and a portion of the framework of the seat proper of FIG. 1, respectively as seen from the left and from the right;

FIGS. 4 and 5 are detail views respectively showing the insides of the right side and of the left side of the framework of the seat back (an internal plate that is part of the left side has, however, been omitted from the drawing for reasons of clarity);

FIG. 5a is a detail view showing the hinge mechanism that is visible in FIG. 5, seen from inside the seat, with an intermediate framework secured to the inner cheek plate of the mechanism and a locking member that secures said intermediate framework to the bottom portion of the seat back;

FIGS. 6 and 7 are views similar to the FIG. 1 view, showing two stages of an operation to fold down the seat back to form a tabletop;

FIG. 8 is a perspective view showing the framework of the seat back in the folded-down tabletop-forming position;

FIGS. 9 and 10 are detail views showing the insides respectively of the right side and of the left side of the framework of the seat back, in the folded-down tabletop-forming position;

FIG. 11 is a view similar to FIG. 1, showing a return stage during which the seat back returns to a normal in-use position after having been folded down to form a tabletop; and

FIGS. 12 to 14 are views respectively similar to FIGS. 8 to 10, showing the framework of the seat back in a position in which access is given to the back seats of the vehicle.

### MORE DETAILED DESCRIPTION

In the various figures, like references designate elements that are identical or similar.

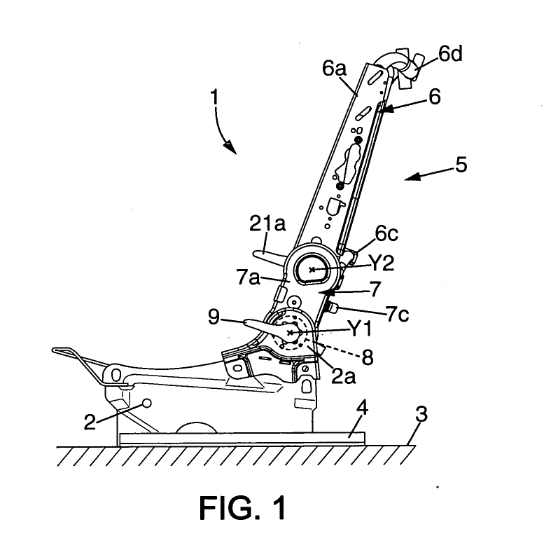

FIG. 1 shows the framework of a motor vehicle seat 1, e.g. a front set, although the invention is naturally applicable to a back seat, or to an intermediate-row seat in a vehicle having more than two rows of seats.

The seat 1 includes a seat proper 2 which can, for example, be mounted to slide backwards and forwards on the floor 3 of the vehicle, by means of a pair of runners 4, only one of which is visible in FIG. 1.

The seat 1 further includes a seat back 5 which, in the example shown, is made up of a top portion 6 and of a bottom portion 7. The bottom portion 7 is mounted to pivot on a support framework 2a that is part of the seat proper 2 about a first transverse horizontal axis Y1, while the top portion 6 of the seat back is mounted to pivot on the bottom portion 7 about a second transverse horizontal axis Y2 that is parallel to the axis Y1 and that is situated thereabove.

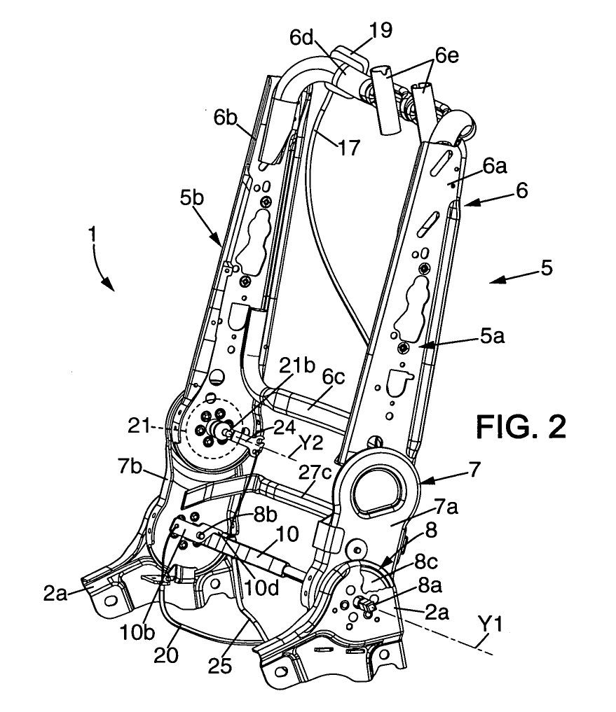

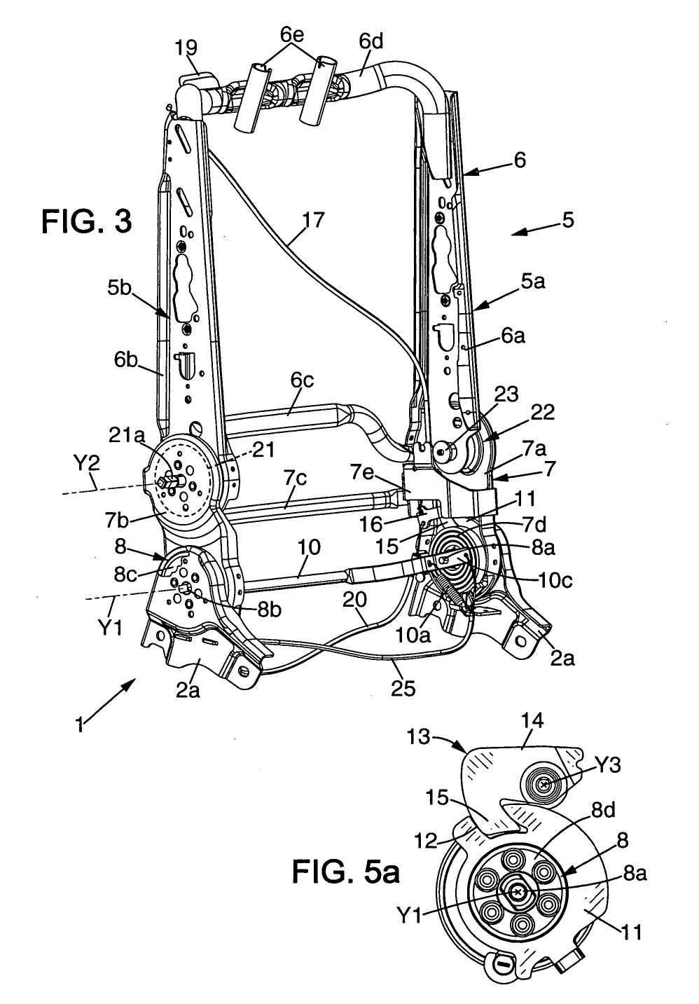

As shown in more detail in FIGS. 2 and 3, the support framework 2a can, for example, be constituted by two sheet metal cheek plates which are fastened rigidly to respective ones of the two main side cheek plates of the framework of the seat proper 2, but naturally, the above-mentioned support framework could also be formed integrally with the main side cheek plates forming the two sides of the seat proper 2, or else be constituted by any framework that is part of the seat proper 2 or that is mounted on the floor of the vehicle.

In addition, the bottom portion 7 of the seat back can comprise a rigid framework having, for example two sheet metal vertical cheek plates 7a, 7b interconnected by a rigid crosspiece 7c, while the top portion 6 of the seat back can, for example, comprise two sheet metal side cheek plates 6a, 6b interconnected by a rigid bottom crosspiece 6c and by a rigid top crosspiece 6d, which top crosspiece can, for example, carry supports 6e such as sleeves designed to receive a headrest.

In the normal in-use position shown in FIGS. 1 to 5, the overall inclination of the seat back 5 can be adjusted by a user by means of one or two hinge mechanisms 8, known per se, that are actuated by a drive member such as a handle 9 so as to cause the bottom portion 7 of the seat back to pivot with the top portion 6 about the first horizontal axis Y1. The or each hinge mechanism 8 can be a mechanism having locking slugs and capable of selectively locking or unlocking the seat back 5 in rotation about the axis Y1. By way of example, the hinge 8 can be of the type descried in Document FR-A-2 740 406.

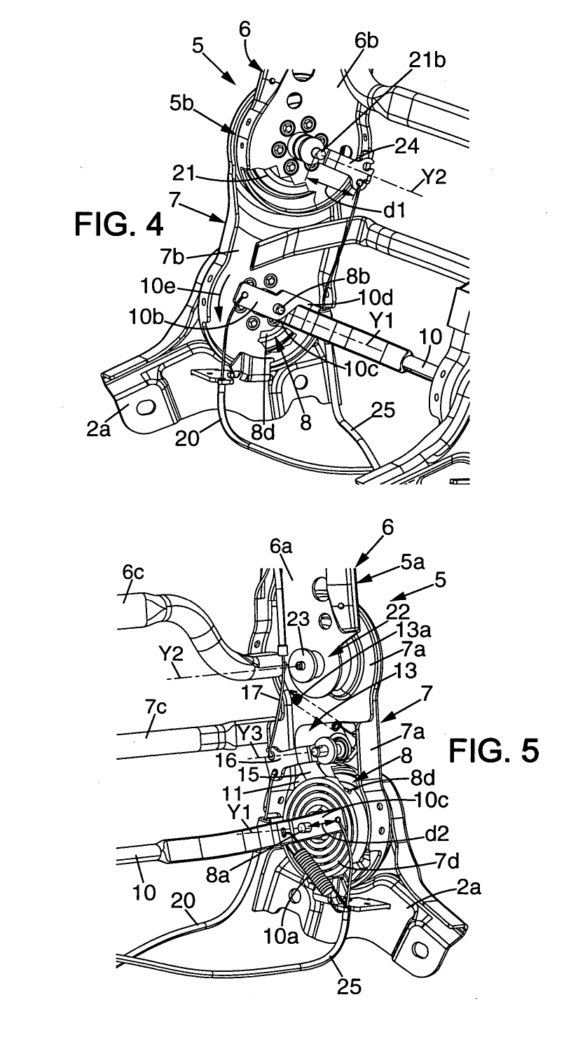

In the example considered herein, the bottom portion 7 of the seat back is mounted to pivot on the support framework 2a by means of two hinge mechanisms 8, disposed respectively on the first and on the second sides 5a, 5b of the seat back (see FIGS. 4 and 5), the two hinge mechanisms being controlled in synchronized manner by the above-mentioned handle 9. The handle 9 in question is fixed to the control shaft 8a of the hinge mechanism situated on the first side 5a of the seat back (FIG. 2), and said control shaft is connected to the control shaft 8b of the hinge mechanism 8 situated on the second side 5b of the seat back, via a rigid coupling bar 10 (see FIGS. 2 to 5) which forms a control that is common to the two hinge mechanisms 8.

As shown in FIGS. 3 and 5, the coupling bar can be urged resiliently by a spring 10a towards a rest position corresponding to the two hinge mechanisms 8 being locked. The coupling bar 10 can, for example, be U-shaped, with, at its ends, two arms 10c parallel to the cheek plates 7a, 7b. The arm 10c situated on the same side as the cheek plate 7a can be fastened rigidly to the corresponding control shaft 8a (FIG. 5), while the other arm 10c is free to pivot about the corresponding control shaft 8b (FIG. 4).

In addition, as shown in FIG. 4, the control shaft 8b is secured to a lever 10c which, towards the rear has an appendage 10d normally held in abutment against the top edge of the coupling bar 10, under drive from resilient means internal to the hinge mechanism 8 situated on the same side as the cheek plate 7b. Thus, when the coupling bar is driven in the direction 10e by the handle 9, it entrains with it the lever 10d and the control shaft 8b, so that the two hinge mechanisms 8 are then unlocked. Conversely, when the lever 10d is actuated in the direction 10e, as explained below, only the hinge mechanism 8 that corresponds to the control shaft 8b is unlocked, while the other hinge mechanism 8 remains locked.

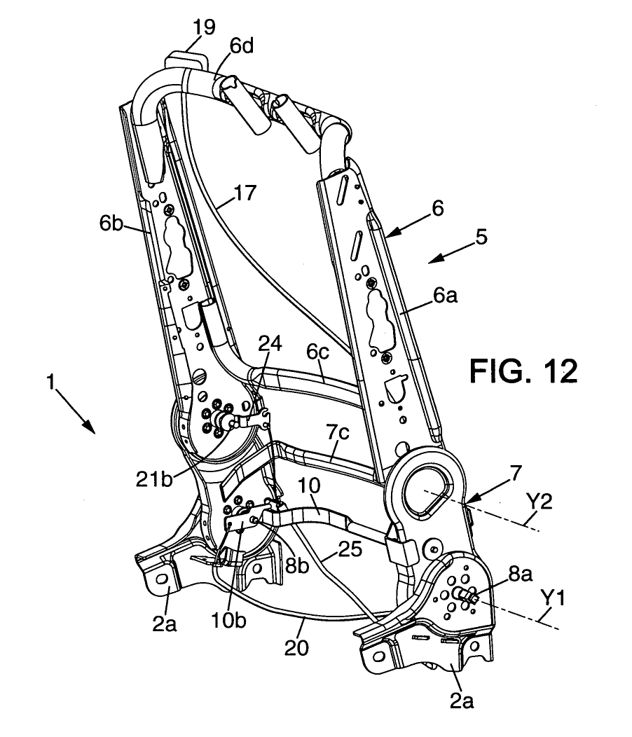

In addition, the bottom portion 7 of the seat back can be connected to the support framework 2a, at least on one side of the seat back, e.g. the first side 5a, by a spring 7d or by any other resilient means urging the seat back as a whole to pivot forwards. Thus, when the two hinge mechanisms 8 are unlocked, the spring 7d causes the seat back 5 as a whole to pivot forwards, e.g. until it reaches the inclined position shown in FIG. 12, which is described in more detail below.

As can be seen in FIGS. 2 to 5 and 5a, each of the hinge mechanisms 8 can conventionally comprise two cheek plates 8c, 8d which define a closed housing containing a locking device actuated by the corresponding control shaft 8a, 8b. On both sides 5a, 5b of the seat back, the cheek plates 8c are secured rigidly to the respective support frameworks 2a, e.g. by welding or the like (see FIGS. 2 and 3).

Similarly, on the second side 5b of the seat back, the other cheek plate 8d of the hinge mechanism 8 is fastened rigidly to the corresponding cheek plate 7b of the bottom portion 7 of the seat back, e.g. by welding or the like.

Conversely, as shown in FIGS. 5 and 5a, on the first side 5a of the seat back, the cheek plate 8d of the hinge mechanism is not fastened to the cheek plate 7a but rather it is fastened to an intermediate framework 11 that is, for example, in the form of a metal plate in which an upwardly-facing notch 12 is provided.

Said intermediate framework 11 can be selectively secured to the bottom portion 7 of the seat back by means of a locking member 13, e.g. in the form of a sheet metal plate and, in the example shown, having a lever 14 mounted to pivot on the cheek plate 7a of the bottom framework 7 about a transverse horizontal axis Y3. Said lever 14 is extended, at its free end, by a hook 15 adapted to penetrate into the notch 12 of the intermediate framework 11 so as to lock the bottom portion 7 of the seat back in rotation about the axis Y1. The locking member 13 is urged resiliently towards this locking position by a spring 13a that is fastened, for example, between the lever 14 and a sheet metal plate 7e fastened to the cheek plate 7a.

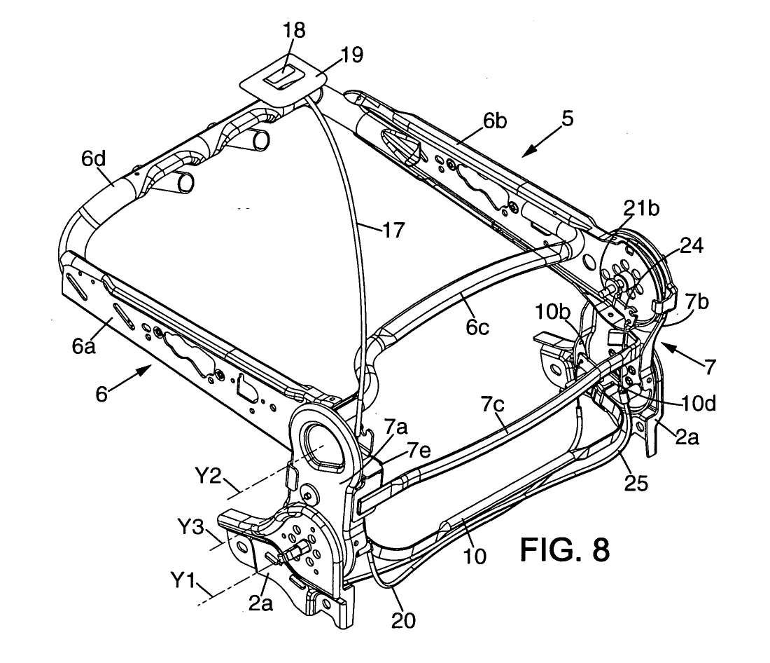

The lever 14 is also secured to a control arm 16 (FIG. 5) whose free end can, for example, be connected to an end of a Bowden cable 17, the other end of the Bowden cable being controlled by a handle or by some other actuating member 18 (FIG. 8) mounted, for example, on a support 19 that is secured to the top crosspiece 6d of the top portion of the seat back.

The free end of the arm 16 is also coupled, e.g. by means of another Bowden cable 20, to the above-mentioned lever 10b, so that actuating the above-mentioned handle 19 not only causes the locking member 13 to pivot, but also causes the lever 10b to pivot in the direction 10e (FIG. 4).

In addition, as shown in FIGS. 1, 4, and 7, it is possible to cause the top portion 6 of the seat back to pivot about the second horizontal axis Y2 parallel to the axis Y1, by actuating an actuating member 21a (FIG. 1) such as a handle or the like, in order to unlock a hinge mechanism 21 (FIG. 4) which can, for example, be identical or similar to the above-mentioned mechanisms 8. The top portion 6 of the seat back is then folded down, e.g. to form a tabletop, substantially horizontally (see FIG. 7).

As shown in FIGS. 2 to 4, the hinge mechanism 21 is mounted between the cheek plates 6b, 7b on the second side 5b of the seat back. On the first side 5a of the seat back, the top portion 6 is connected to the bottom portion 7 of the seat back by a freely pivoting mount 22 consisting, for example, merely in a pivot 23 which interconnects the frameworks of said top portion and of said bottom portion 7 on the first side 5a of the seat back.

The control shaft 21b of the hinge mechanism 21 can advantageously be secured to a lever arm 24 whose free end is fastened to an end of a Bowden cable 25, the other end of said Bowden cable being fastened to an arm 10c that is part of the coupling bar 10, e.g. on the first side 5a of the seat back, so that actuating the control shaft 21b to unlock the hinge mechanism 21 also unlocks the two above-mentioned hinge mechanisms 8.

The above-described seat operates as follows.

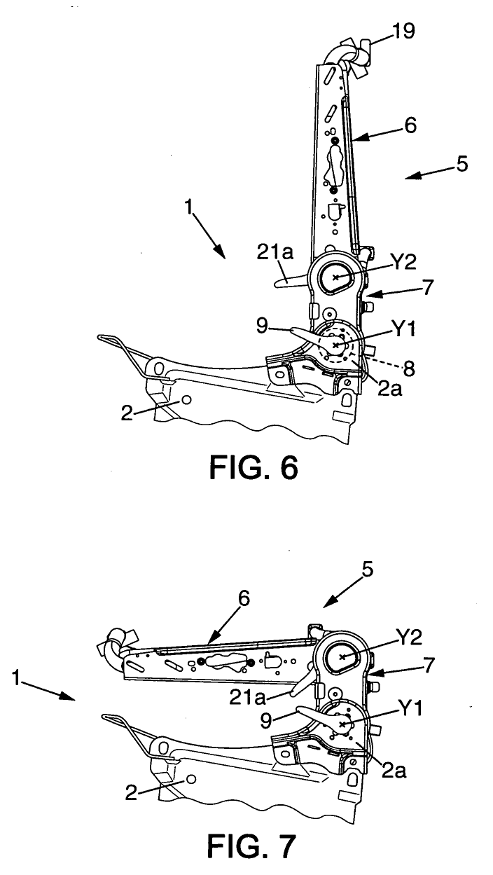

As shown in FIG. 6, when a user wishes to fold down the seat back of the seat into a tabletop-forming position, with its top portion 6 being substantially horizontal, the user actuates the handle 21a. Advantageously, the above-mentioned Bowden cable 25 is mounted so that the hinges 8 are unlocked during a first portion of the actuating stroke of the handle 21a, before the hinge 21 is unlocked. To this end, the cable 25 can, for example, be fastened to the lever arm 24 at a distance d1 from the axis Y2 (see FIG. 4) that is greater than the distance d2 (FIG. 5) between the fastening point at which the other end of the cable 25 is fastened to the arm 10c of the coupling bar and the axis Y1 (FIG. 5) so that a given angular displacement of the arm 24 results in a greater angular displacement of the coupling bar 10.

Thus, as shown in FIG. 6, during the first portion of the actuating stroke of the handle 21a, because only the hinge mechanisms 8 are unlocked, the seat back 5 pivots forwards as a whole until it reaches an abutment position, under the effect of the above-mentioned spring 7d.

During the remainder of the actuating stroke of the handle 21a, the hinge mechanism 21 is in turn unlocked, so that the top portion 6 of the seat back can pivot relative to the bottom portion about the axis Y2, until it reaches its tabletop-forming position, in which it is substantially horizontal, shown in FIG. 7. Advantageously, the hinge mechanism 21 can be organized to have an angular range over which locking between the top portion 6 and the bottom portion 7 of the seat back is inhibited, and to allow the hinge 21 to be relocked only in the tabletop-forming position shown in FIG. 7. The means making it possible to obtain such an angular range over which locking is inhibited are well known in themselves, and can be implemented, for example, as described in above-mentioned Document FR-A-2 740 406.

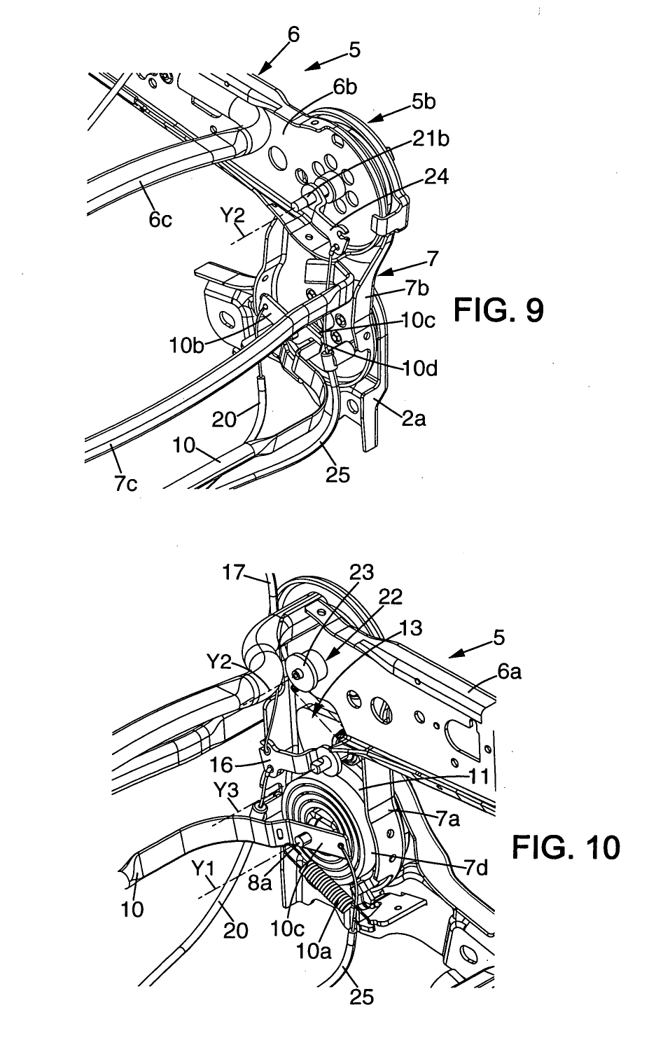

Thus, when the seat back is in the tabletop-forming position shown in FIGS. 7 to 10, the handle 21a resumes its initial position, and the hinge mechanisms 8, 21 re-lock.

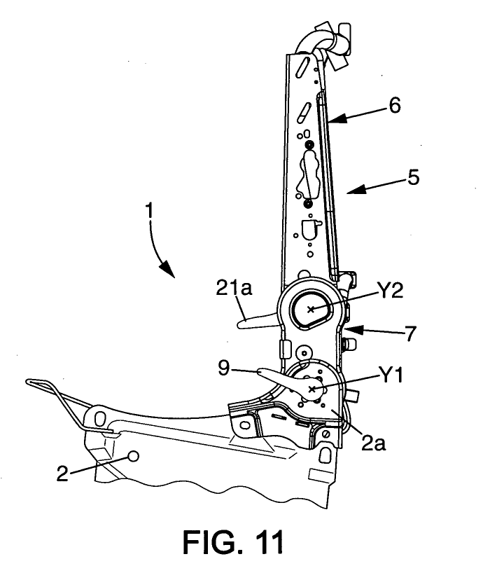

Starting from the tabletop-forming position that is shown in FIG. 7, when the user wishes to put the seat back 5 back into the in-use position, the user actuates the handle 21a again, thereby unlocking the hinges 8 and 21, and the user then stands up the top portion 6 of the seat back by pivoting it about the axis Y2. As soon as this pivoting movement starts, the user can release the handle 21a, and the hinge mechanism 21 re-locks automatically provided that the seat back exits from the angular range over which locking of the hinge mechanism 21 is inhibited. In this position, which is shown in FIG. 11, the bottom portion 7 of the seat back is still tilted forwards, in the position shown in FIG. 6, and in order to resume a comfortable in-use position, it is necessary for the user to actuate the handle 9, e.g. while sitting on the seat, and simultaneously exerting a force on the seat back 5 so as to cause it to pivot backwards against the drive from the above-mentioned spring 7d.

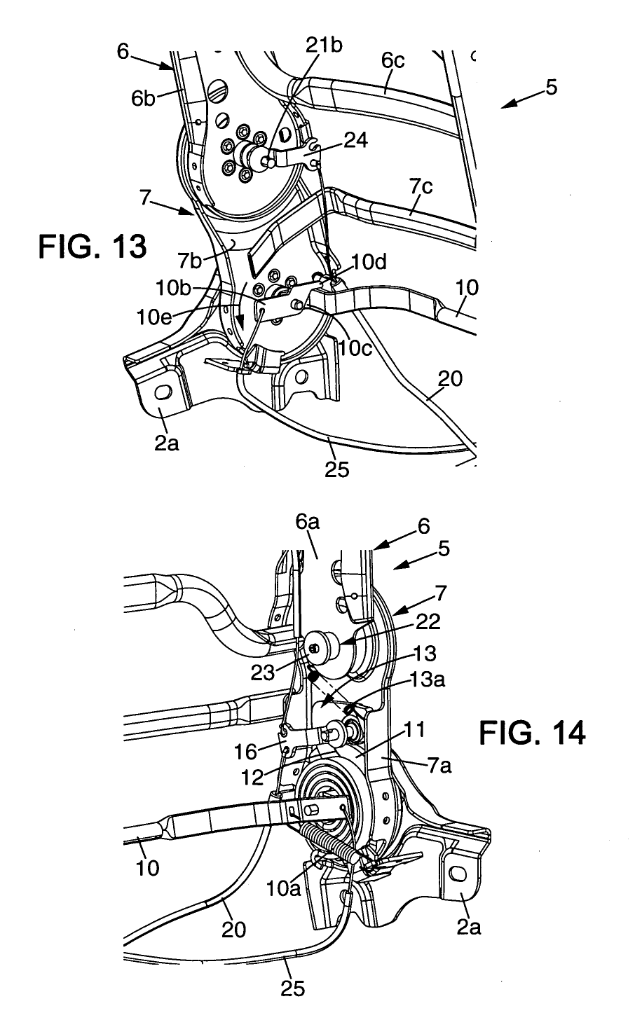

Finally, when the user of the seat wishes to tilt the seat back 5 of the seat forwards into the position shown in FIGS. 12 to 14, e.g. for easier access to the space situated behind the seat 1 (in particular to access the back seats of the vehicle in a hatchback vehicle), the user actuates the above-mentioned handle 18 which, via the cable 17, actuates the locking member 13 so that its hook 15 is disengaged from the corresponding notch 12 of the intermediate framework 11, and simultaneously, the cable 20 actuates the lever 10b in the direction 10e so as to unlock the hinge mechanism 8 situated on the same side as the cheek plate 7b. The seat back 5 as a whole then pivots forwards about the axis Y1, until it reaches the abutment position, under drive from the spring 7d. Simultaneously, the runners 4 of the seat can optionally be unlocked, e.g. by a cable (not shown), as is well known per se, so that the user can move the seat 1 as a whole forwards into a forward abutment position, at the same time as the seat back 5 pivots forwards.

It should be noted that, as soon the seat back 5 starts to pivot forwards, the locking member 13 is held in the unlocked position, by the hook 15 pressing against the edge of the intermediate framework 11 outside the notch 12, so that not only does the locking member 13 remain in the unlocked position, but also the hinges 8 themselves remain in the unlocked state. Thus, when the user wishes to put the seat 1 back into the normal position, it suffices for the user to cause the seat back 5 to pivot backwards manually, optionally while also causing the seat as a whole to slide backwards on the runners 4. Once the seat back 5 has been stood up sufficiently for the hook 15 to penetrate into the notch 12 of the intermediate framework 11, the locking member 13 returns to the locking position, so that the hinge mechanisms 8 can also re-lock, and the seat resumes its in-use position.

1. A vehicle seat comprising a seat back and a seat proper, the seat back having opposite first and second sides, and comprising, at least:
a bottom portion mounted to pivot on a support framework about a first transverse horizontal pivot axis;
a top portion mounted to pivot on the bottom portion about a second transverse horizontal pivot axis, parallel to the first axis;
at least one first hinge mechanism adapted to make it possible to adjust the angular position of the seat back relative to the support framework, said hinge mechanism having a first cheek plate fastened to the support framework and a second cheek plate connected to the bottom portion of the seat back by a locking member that is movable between firstly a locking position in which said locking member secures the second cheek plate to the bottom portion of the seat back at least in a normal in-use angular position, and secondly an unlocking position in which said locking member makes it possible for the bottom portion of the seat back to pivot freely relative to the support framework, at least for the purpose of folding down said bottom portion from its normal in-use position to a tilted-forwards position;
a second hinge mechanism connecting the top portion of the seat back to the bottom portion and actuatable so as selectively either to secure the top portion of the seat back to the bottom portion, or to allow the top portion of the seat back to pivot relative to the bottom portion about the second axis, at least for the purpose of folding down said top portion from the normal in-use position to a folded-down forwards position;
wherein the first and second hinge mechanisms are disposed on respective ones of the first and the second sides of the seat back, the top portion of the seat back being connected to the bottom portion of said seat back via a freely pivoting mount on the first side of the seat back.

2. A seat according to claim 1, in which the locking member comprises a lever that is mounted to pivot on the bottom portion of the seat back, and said lever can be moved towards the second axis when the locking member goes from its locking position to its unlocking position.

3. A seat according to claim 2, in which the second cheek plate of the first hinge mechanism is secured to an intermediate framework provided with a notch, and the lever is provided with a hook adapted to engage into said notch in said locking position.

4. A seat according to claim 1, in which the bottom portion of the seat back is connected to the support framework on the second side of the seat back, by a third hinge mechanism similar to the first hinge mechanism, the first and third hinge mechanisms being connected to a common control adapted to control said first and second hinge mechanisms in synchronized manner when a first control member is actuated so as selectively to lock or release the bottom portion of the seat back in rotation relative to the support framework, and the bottom portion of the seat back is urged resiliently to pivot forwards relative to the support framework.

5. A seat according to claim 4, in which the common control of the first and third hinge mechanisms is coupled to a second control member actuating the second hinge mechanism, so as to unlock the first and third hinge mechanisms when said control member is actuated to unlock the second hinge mechanism.

6. A seat according to claim 5, in which the common control of the first and third hinge mechanisms is connected to said control member of the second hinge mechanism by coupling means adapted to unlock the first and third hinge mechanisms prior to unlocking the second hinge mechanism when said control member is actuated.

7. A seat according to claim 5, in which the common control of the first and third hinge mechanisms is connected to the control member of the second hinge mechanism by means of a first Bowden cable.

8. A seat according to claim 4, in which the locking member is coupled to an actuating member that controls the third hinge mechanism so as to unlock said third hinge mechanism when the locking member is in the unlocking position, said actuating member being adapted not to act on the common control when it is actuated, so that the first hinge mechanism then remains locked.

9. A seat according to claim 8, in which the locking member is coupled to the actuating member of the third hinge mechanism via a second Bowden cable.
